(19) United States
(12) Patent Application Publication
(10) Pub. No.: US 2025/0083415 A1
(43) Pub. Date: Mar. 13, 2025

(54) SEALED AND CLAMPED LAMINATED GLAZING HAVING SEPARATE SEALING AND POSITIONING FUNCTIONS

(71) Applicant: SAINT-GOBAIN GLASS FRANCE, COURBEVOIE (FR)

(72) Inventors: Jean Charles SAUVESTY, SULLY SUR LOIRE (FR); Ludovic CHAUVETTE, PERIGNY (FR); Jean Benoit MAYEUX, SULLY SUR LOIRE (FR); Vincent RACHET, SULLY SUR LOIRE (FR)

(21) Appl. No.: 18/728,346

(22) PCT Filed: Jan. 10, 2023
(86) PCT No.: PCT/FR2023/050032

§ 371 Date: Jul. 11, 2024

(30) Foreign Application Priority Data
Jan. 13, 2022 (FR) FR2200271

(51) Int. Cl. B32B 17/10; B32B 7/12

(52) U.S. Cl. CPC B32B 17/10064; B32B 7/12; B32B 17/10302; B32B 17/10743; B32B 2250/03; B32B 2307/7376; B32B 2605/18

(57) ABSTRACT

A laminated glazing unit includes a glass sheet, the border of which is set back relative to that of a structural block, the edge of the glass sheet and the edge of the adhesive interlayer bonding the sheet and the block, the surface of the block protruding relative to the sheet, the edge of the block and a peripheral portion of the free surface of the block being covered by a seal, the laminated glazing being clamped to the mounting structure by a pane retainer, the seal extending in the direction of the pane retainer and/or in the direction of the structure in a rigid protrusion having a small depth and a flexible protrusion having a large depth.

The present application relates to clamped glazing units, which are to guarantee a sealing function at the interface with the structure in which they are installed. A clamped glazing unit is attached to a mounting structure (for example a commercial aircraft fuselage) by means of a pane retainer (also called a “liner”) which presses the glazing unit against the structure.

The periphery of the clamped (or pinched) glazings is traditionally produced by overmolding a joint (silicone or equivalent). This joint ensures the double sealing function with the mounting structure and placing the equipment in this structure, which delimits a pressurized or non-pressurized inner volume. There may therefore exist a pressure differential between the inner and outer main faces of the glazing.

The sealing function is ensured by the presence (one or more) of lips, located on one or both of the surfaces in contact (pane retainer side and/or structure side). Various embodiments have been imagined for these recent decades, including zero to three lips, in interior or exterior parts. The positioning is ensured by the clamping of the liner on the structure, compressing the entire seal (body+lips). According to the known technique, the two sealing and positioning functions are carried out by an operation (clamping) compressing a part (complete joint) composed of a single material, such as silicone.

By thus carrying out both functions through a single operation, the known technique binds and limits their performance relative to one another. Mechanically, the system is similar to placing two springs in series enclosing the glazing, with the whole being inserted between the structure and the pane retainer. Glazing, structure, and pane retainer can be considered to be infinitely rigid. The inner, respectively outer, parts of the seal separate a surface of the glazing oriented toward the inner volume (of the commercial aircraft, for example of the cockpit) in the mounting position, and the mounting structure, respectively a surface of the glazing oriented toward the outside atmosphere in the mounting position, and the pane retainer. These inner and outer parts of the seal can be modeled by springs of variable stiffnesses depending on the shape and the material used.

The clamping operation produces a deformation of the joint due to compression.

From the ratio of the stiffnesses and the free thicknesses of the interior and exterior seals (springs) depends on the position of the exterior surface of the glazing with respect to the pane retainer (level difference), without a pressure differential between the two faces of the glazing.

The stiffness of the exterior seal determines the movement of the glazing under pressure, and therefore the change in level difference during a flight. A lower stiffness produces a greater movement of the glazing.

Ensuring good sealing regardless of the actual shape of the structure (taking into account dimensional and geometric tolerances) requires a seal (spring) that has a large amplitude of deformation: Low flexibility causes a high level of stress, which harms the aging of the equipment and of the mounting structure, while high flexibility reduces the holding in position because the glazing then becomes sensitive to variations in pressure (and vibratory phenomena).

The current technique partially resolves this conflict by adjusting the shape of the lips and therefore, for a given material (constant Young's modulus), the stiffness.

In order to minimize wear phenomena on apparatuses with weaker structures, the amplitude of deformation of the joint is minimized in order to limit the stresses on the structure, and may lead to sealing problems. In practice, the material used is a silicone seal chosen for its durability, its processability, and its performance with respect to the environment (resistance to temperatures, compatibility with fluids, adhesion, etc.). Since the material is fixed, only the shape of the lips remains to adjust the stiffness and to secure the sealing/holding-in-position compromise.

The inventors have figured out how to dissociate the sealing part from the holding-in-position part. The principle is the parallel setting of springs of different stiffnesses, one ensuring the positioning (high stiffness and low deformation amplitude) and the other ensuring the sealing (low stiffness and high deformation amplitude). The flexible part can be made by design (tapered shape such as a comma, etc.) or by a material (low Young's modulus). The maximum movement, and therefore the associated effect, will be limited by the reduced deformation of the rigid part that will ensure holding in position.

The desired aim has been achieved by the invention, which, more precisely, has as its object a laminated glazing unit comprising at least one first sheet of protective glass and a structural block comprising at least one second sheet of glass bonded to the first by means of a first adhesive interlayer and optionally at least one third sheet of glass bonded to the second by means of at least one optional second adhesive interlayer, the first glass sheet being intended to form the surface of the laminated glazing in contact with the outside atmosphere, in which the border of the first glass sheet is set back relative to that of the second and of said at least one optional third glass sheet, the edge of the first glass sheet and of the first adhesive interlayer, the peripheral surface of the second glass sheet protruding relative to the first glass sheet, the edge of the second glass sheet, of said at least one second adhesive interlayer and of said at least one third glass sheet if any, and a peripheral part of the free surface of the sheet constituting the main surface of the laminated glazing unit opposite that constituted by the first glass sheet, are covered by a seal for protecting against air and water, and against solar radiation and fluids, the laminated glazing can be secured to the mounting structure by means of a pane retainer which presses on said protrusion with respect to the first sheet of glass, characterized in that the seal extends towards the pane retainer and/or the mounting structure, in at least one relatively rigid protrusion with a relatively small depth, and at least one relatively flexible protrusion with a relatively large depth.

The structural block provides the mechanical strength required for each application of the laminated glazing in question, in particular with respect to possible pressurization of the delimited interior volume, and to the aerodynamic pressure proportional to the speed of movement of the laminated glazing unit. The structural block may consist only of said second glass sheet, called a structural sheet having an elastic modulus at least equal to 1500 MPa for example. The structural block may consist of said second glass sheet bonded to said third glass sheet by means of said second adhesive interlayer. The structural block may also comprise more than two glass sheets, two such consecutive sheets being bonded by an adhesive interlayer.

The composition of the first and second glass sheets will be seen in detail below. Generally, the first glass sheet is a thin nonstructural protection sheet, that is, it does not provide the mechanical strength required for a monolithic glazing for example, and its main face internal to the laminated structure bears a network of wires or a thin layer such as Indium Tin Oxide (ITO), silver, gold or equivalent, which are electrically conducting and provide antifreeze/deicing.

The seal for protecting against air and water, and against solar radiation and fluids, is a peripheral seal made of elastomeric polymer material, in particular injectable or extruded, such as silicone, polyurethane (PU), polysulfide elastomer.

Preferably, said protrusions extend in the direction perpendicular to the peripheral surface of the second glass sheet at the edge protruding relative to the first glass sheet, all the way to the pane retainer on the one hand, and/or in the direction perpendicular to a peripheral part of the free surface of the sheet constituting the main surface of the laminated glazing unit opposite that consisting of the first glass sheet, all the way to the mounting structure, on the other hand. All the protrusions are in contact with the pane retainer and/or the mounting structure, in the assembly position of the assembly, that is to clamp/secure the pane retainer onto the mounting structure, the flexible protrusions being, in particular, “compressed” on the pane retainer and/or the mounting structure until the rigid protrusions abut against them.

Preferably, the laminated glazing unit comprises at least a third sheet of glass that is linked to the second sheet of glass by a second adhesive interlayer. This structure can be perfectly functional as a commercial aircraft cockpit glazing unit, for example.

Preferably, said at least one relatively rigid protrusion is made of a material with a Young's modulus between 10 and 20,000 MPa and said at least one relatively flexible protrusion is made of a material with a Young's modulus of between 0.01 and 100 MPa, significantly less than that of the material of the relatively rigid protrusion.

Preferably, the first glass sheet is made of a mineral glass with a thickness of between 0.5 and 5, preferably between 2 and 4 mm, or made of a polymer material such as poly(methyl methacrylate) (PMMA) with a thickness of between 0.5 and 5 mm. It is a nonstructural protection sheet for protecting the underlying structural block. A mineral glass here refers to a soda-lime, aluminosilicate, borosilicate glass, optionally hardened, thermally tempered, or chemically strengthened. Transparent polymer materials other than PMMA can be used, in particular polycarbonate (PC), polyethylene terephthalate (PET) or polyurethane (PU). When the first glass sheet is made of a polymer material such as PC, its free surface is advantageously provided with an anti-scratch coating or varnish of the polysiloxane, hydrophilic, hydrophobic, etc. type.

Preferably, the second glass sheet and, if applicable, the third glass sheet and so on are made of a mineral glass with a thickness of between 1.6 and 10 mm, or made of a polymer material such as poly(methyl methacrylate) (PMMA) with a thickness of between 3 and 30, preferably at most 20 mm. These are structural sheets or structural plies (see above).

Preferably, the first adhesive interlayer, and the second adhesive interlayer if any, are made of thermoplastic polyurethane (TPU), polyvinyl butyral (PVB), ethylene/vinyl acetate (EVA) copolymer, ionomer resin, cast resin, the thickness of the first adhesive interlayer is between 3 and 10, preferably 4 and 8 mm, and the thickness of the second adhesive interlayer if any, and, if applicable, of the following layers is between 0.5 and 4, preferably at most equal to 2 mm.

Another object of the invention consists in applying a laminated glazing as described above to a pinched glazing, of the aeronautical type (cockpit and window) for pressurized or non-pressurized, fixed or rotary wing aircraft, railway, armored vehicle, or boat (wheelhouse, window) type. Mention is made of a cockpit glazing for a long-haul commercial aircraft or for a medium-haul mail aircraft.

The invention will be better understood in light of the description of the appended drawings, wherein:

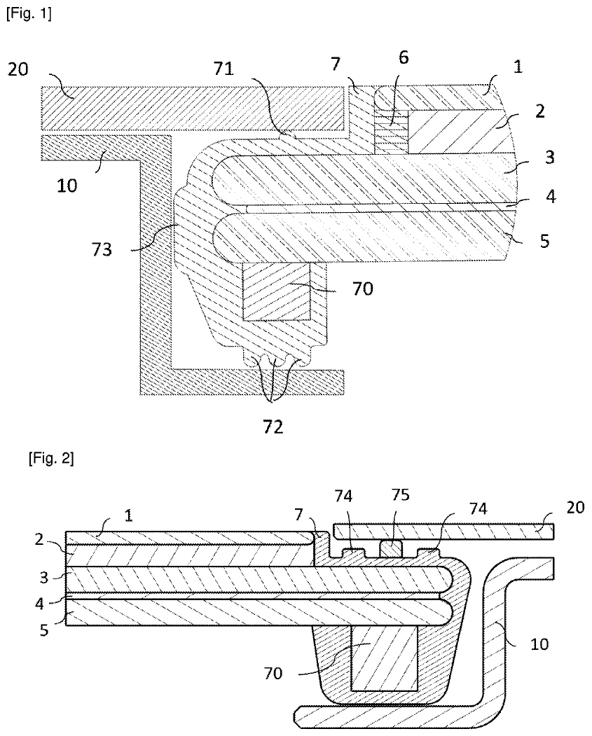

FIG. 1 schematically shows, in cross-section, a laminated glazing unit of the prior art,

FIG. 2 schematically shows, in cross-section, a first form of the first main variant of a laminated glazing unit according to the invention;

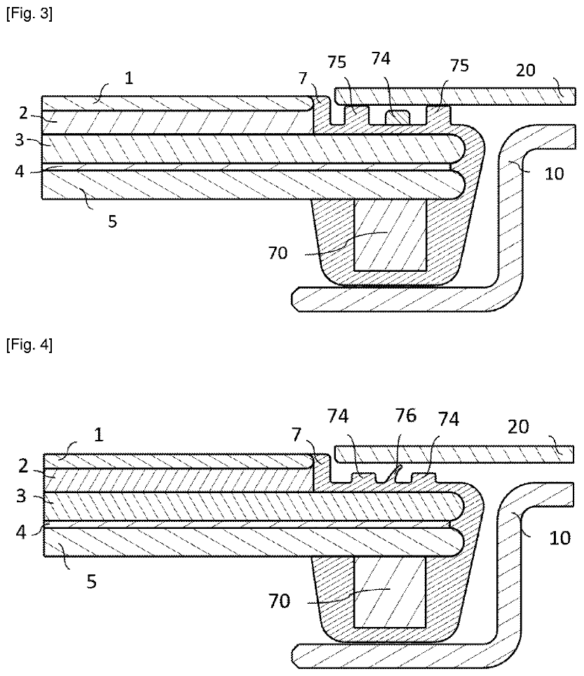

FIG. 3 schematically shows, in cross-section, a second form of this first main variant, and

FIG. 4 schematically shows, in cross-section, a second main variant of a laminated glazing unit according to the invention.

With reference to FIG. 1, a laminated glazing of the prior art comprises a first glass sheet 1 forming an exterior face of the glazing, having a thickness of 3 mm, which is bonded to a second glass sheet 3 having a thickness of 8 mm by a first polyurethane (PU) adhesive interlayer 2 having a thickness of 5.76 mm.

A third glass sheet 5 having a thickness of 8 mm is bonded to the second 3 by a second polyvinyl butyral (PVB) adhesive interlayer 4 having a thickness of 2 mm.

The edge faces of the second and third glass sheets 3, 5 are optionally protected from impacts by relatively hard elastomer sheets, not shown.

The border of the first glass sheet 1 is set back relative to that of the second sheet 3. The edge of the first glass sheet 1, the edge of the first adhesive interlayer 2 and a part of the surface of the second glass sheet 3 protruding relative to the first glass sheet 1 is covered by a seal 7 for protecting against air and water, made of silicone. If necessary, a drop of polysulfide, not shown, in particular covers the interface between the first glass sheet 1, the seal 7 for protecting against air and water, the pane retainer 20 and the mounting structure 10, so as to provide the laminated glazing unit with aerodynamic continuity between glazing unit and mounting structure 10 such as an airplane structure, and good inertia to treatment fluids such as aeronautical fluids, cleaning products, degreasing products, glycol for ground defrosting and the like.

The exterior surface of the silicone seal 7 has a lip 71 sealing against the pane retainer 20, and three lips 72 for sealing against the mounting structure 10. The silicone seal 7 has a lateral protrusion 73 for abutment, bearing, and sliding on the mounting structure 10. In addition, in the lower part of the silicone seal 7, a thickness spacer 70 (or stiffening) made from a harder material than the silicone is inserted so as to guarantee that the laminated glazing is indeed held in its mounting position, by exerting a certain pressure, such as by pinching. The thickness spacer 70 is solid, but may comprise recesses.

The face of the glass sheet 1 oriented toward the interior of the laminated structure bears a heating layer, consisting of indium tin oxide (ITO) or an equivalent such as gold, silver multilayer, ZnO:Al, SnO₂:F, etc. The heating layer is effective to deice the exterior surface of the glass sheet 1.

A sealing mastic 6 consisting of polysulfide partially obstructs the periphery of the first adhesive interlayer 2, between the first and second glass sheets 1, 3.

The laminated glazing unit is attached to the fuselage 10 of the commercial aircraft by means of a window retainer 20 (or liner) bolted to the fuselage 10, and which exerts a bearing force on the overhang of the second glass sheet 3 relative to the first 1, which bearing force is exerted by means of the silicone seal 7, whose lips 71, 72 in particular ensure the sealing between the silicone seal 7 and the liner 20 on the one hand, and the mounting structure 10 on the other hand.

Referring to FIG. 2, a laminated glazing unit according to the invention is distinguished from those of the prior art by its silicone seal 7. The latter comprises two protrusions 74 with relatively small height (or depth), surrounding a protrusion 75 with relatively large height (or depth). The three protrusions 74, 75 extend in the direction perpendicular to the peripheral surface of the second glass sheet 3 protruding relative to the first glass sheet 1, all the way to the pane retainer 20, at least in a state (not shown) for mounting, fastening, bolting, clamping of the pane retainer 20 on the mounting structure 10. The two protrusions (or lips) 74 are made of a relatively rigid material having a Young's modulus of 10 MPa, while the protrusion (lip) 75 is made of a flexible material having a Young's modulus of 0.1 MPa. The protrusion 75 is bonded or overmolded. Alternatively or additionally, protrusions not shown, equivalent and similar to the protrusions 74, 75, are likely to extend in the direction perpendicular to a peripheral part of the free surface of the sheet 5 (constituting the main surface of the laminated glazing unit opposite that consisting of the first glass sheet 1, to the lower surface of the seal 7, to the mounting structure 10, after clamping the pane retainer 20 onto the mounting structure.

Referring to FIG. 3, the seal 7 according to the invention is another embodiment of the main variant of FIG. 2, in which the relatively rigid protrusion or lip 74 of small height or depth is surrounded between two more flexible protrusions 75 of greater height/depth, on the material from which it is bonded or overmolded.

FIG. 4 shows another main variant of the laminated glazing unit of the invention, wherein the silicone seal 7 consists of the only rigid material of the seals shown in FIGS. 2 and 3, and the flexible lip 76 is obtained by a tapered comma-shaped profile.

1. A laminated glazing unit comprising at least one first sheet of protective glass and a structural block comprising at least one second glass sheet bonded to the first by a first adhesive interlayer and optionally at least one third glass sheet bonded to the second by at least one optional second adhesive interlayer, the first glass sheet being intended to form a surface of the laminated glazing in contact with the outside atmosphere, in which a border of the first glass sheet is set back relative to a border of the second sheet and a border of said at least one optional third glass sheet, an edge of the first glass sheet and of the first adhesive interlayer, a peripheral surface of the second glass sheet overhanging relative to the first glass sheet, an edge of the second glass sheet, of said at least one second adhesive interlayer and of said at least one third glass sheet if any, and a peripheral part of the free surface of the sheet constituting the main surface of the laminated glazing unit opposite that constituted by the first glass sheet, are covered by a seal for protecting against air and water, and against solar radiation and fluids, the laminated glazing unit being secured to a mounting structure by a pane retainer which presses on said overhang with respect to the first glass sheet, wherein the seal extends towards the pane retainer and/or the mounting structure, in at least one relatively rigid first protrusion with a relatively small depth, and at least one relatively flexible second protrusion with a relatively large depth.

2. The laminated glazing unit according to claim 1, wherein said first and second protrusions extend in a direction perpendicular to the peripheral surface of the second glass sheet protruding relative to the first glass sheet, all the way to the pane retainer on the one hand, and/or in a direction perpendicular to a peripheral part of a free surface of the second or optional third glass sheet constituting the main surface of the laminated glazing unit opposite that consisting of the first glass sheet, all the way to the mounting structure, on the other hand.

3. The laminated glazing unit according to claim 1, further comprising said at least one third glass sheet connected to the second glass sheet by a second adhesive interlayer.

4. The laminated glazing unit according to claim 1, wherein said at least one relatively rigid first protrusion is made of a material with a Young's modulus between 10 and 20,000 MPa and said at least one relatively flexible second protrusion is made of a material with a Young's modulus of between 0.01 and 100 MPa, significantly less than a Young's modulus of the material of the relatively rigid first protrusion.

5. The laminated glazing unit according to claim 1, wherein the first glass sheet is made of mineral glass having a thickness of between 0.5 and 5 mm, or is made of a polymer material having a thickness of between 0.5 and 5 mm.

6. The laminated glazing unit according to claim 1, wherein the second glass sheet and, the optional third glass sheet are made of mineral glass having a thickness of between 1.6 and 10 mm, or are made of a polymer material having a thickness of between 3 and 30, preferably at most 20 mm.

7. The laminated glazing unit according to claim 1, wherein the first adhesive interlayer and the optional second adhesive interlayer are made of thermoplastic polyurethane (TPU), polyvinyl butyral (PVB), ethylene-vinyl acetate (EVA) copolymer, ionomer resin, cast resin, wherein a thickness of the first adhesive interlayer is between 3 and 10 mm, and wherein a thickness of the optional second adhesive interlayer, and, any subsequent layers, is between 0.5 and 4 2 mm.

8. A method comprising providing a laminated glazing unit according to claim 1 to a clamped aeronautical glazing for pressurized or non-pressurized, fixed or rotary wing aircraft, railway, armored vehicle.

9. The laminated glazing unit according to claim 5, wherein the first glass sheet is made of mineral glass having a thickness of between 2 and 4 mm, or the polymer material is poly(methyl methacrylate)(PMMA).

10. The laminated glazing unit according to claim 6, wherein the polymer material is poly(methyl methacrylate)(PMMA).

11. The laminated glazing unit according to claim 7, wherein the thickness of the first adhesive interlayer is between 4 and 8 mm, or wherein the thickness of the optional second adhesive interlayer and, any subsequent layers, is at most equal to 2 mm.

12. The method according to claim 8, wherein the clamped aeronautical glazing is a cockpit or a window.

13. A method comprising providing a laminated glazing unit according to claim 1 to a clamped boat glazing.
